(19) United States
(12) Patent Application Publication
(10) Pub. No.: US 2011/0033822 A1
(43) Pub. Date: Feb. 10, 2011

(54) Endodontic File

(76) Inventors: James Bahcall, Buffalo Grove, IL (US); Kris Olsen, Whitefish Bay, WI (US); James DeVengencie, Grafton, OH (US); Mark Arthur Fiorina, Elm Grove, WI (US); Mark Andrew Fiorina, Brookfield, WI (US)

Correspondence Address: BOYLE FREDRICKSON S.C., 840 North Plankinton Avenue, MILWAUKEE, WI, 53203, US

(21) Appl. No.: 12/850,314

(22) Filed: Aug. 4, 2010

Related U.S. Application Data
(60) Provisional application No. 61/231,155, filed on Aug. 4, 2009.

(51) Int. Cl. A61C 5/02; B23H 9/14

(52) U.S. Cl. 433/102; 219/69.17

(57) ABSTRACT

An endodontic instrument eliminates the need for conventional flutes by employing a tapered tip having an axially extending relief surface such as a flat permitting the passage of liquid and the ejection of debris from the tooth. In one embodiment, an abrasive surface of the tapered tip is produced by electrical discharge machining which provides randomly arrayed microscopic pits directly in the metallic surface of the instrument.

### CROSS REFERENCE TO RELATED APPLICATION

This application claims the benefit of U.S. provisional application 61/231,155 filed Aug. 4, 2009 hereby incorporated by reference.

### BACKGROUND OF THE INVENTION

The present invention relates to the field of endodontics and, in particular, to improved endodontic instruments for operating within the tooth root, dental pulp and surrounding area.

The dental pulp is made up of vascular and neural tissue found within a tooth. It is surrounded by the hard mineralized tissue of dentin, cementum, and enamel. The root canal is the pulp-filled channel within the hard tissue in the tooth's root structure. In the event that the pulp tissue becomes inflamed or infected, the treatment is to remove the pulp using fine instruments, known as endodontic files, capable of getting into narrow canals. These files are typically made of surgical metals, such as stainless steel, and more recently nickel titanium, and can be used by hand in a reciprocal motion or in an electric rotary handpiece device.

The current metal rotary endodontic files on the market are manufactured in various tip sizes and tapers that allow the instrument to remove pulp and enlarge the canal walls. The canals narrow and curve as they extend down through the tooth's root. As such, to reach the end of a root canal system where it is the narrowest, very small shank diameter files are used to manipulate through the curved path of the canal while removing pulp and enlarging the canal walls.

The current endodontic file cuts by the flutes engaging into the soft tissue of the pulp and the hard tissue of the canal wall. Advancements in the construction of endodontic files have given rise to many different designs of these flutes. The material composition of rotary endodontic files has improved as well, such as the use of nickel titanium, which allows the file to flex through the canal bends and thereby improve the ability to remove pulp tissue while enlarging the canal in the smaller regions with a tooth's root.

One of the major drawbacks with the current nickel titanium rotary endodontic instruments is the nickel titanium has a propensity to break in the root canal while in use. It has been documented in the endodontic literature that the reason for this breakage is there are two main forces that are placed on a file during usage: cyclic fatigue and torsional stress. Cyclic fatigue is the breakage of the file due to continuous use while it is freely rotating in the canal. Torsional stress occurs when a file binds within the canal due to the engaging of the flutes in the soft or hard tissue of the canal while the instrument continues to rotate.

Nickel-titanium rotary endodontic files are manufactured by machining the flute design into the metal cylindrical blank. These nickel titanium blanks inherently have imperfections in the metal that are further weakened by the machining of the flutes. When these files are then placed under clinical usage it is not uncommon for a file to break when performing endodontic treatment on a patient.

Replacement of the file delays the procedure and can be costly. Moreover, when this happens it is possible for the broken end of the file to become lodged within the canal. This can affect the long-term prognosis of the endodontic treatment because the lodged file can block the remaining portion of the canal and prevent the inflamed or infected pulp tissue from being removed.

### SUMMARY OF THE INVENTION

The present invention provides an endodontic instrument that may replace conventional nickel titanium devices to provide reduced risk of breaking through the use of a robust tapered shaft without helical machined flutes. A relief surface, for example a flat running down at least a portion of the taper, provides a passageway for the exchange of fluid in the removal of debris from the tooth channel during cutting. In one embodiment, the cutting surface on the taper is formed from microscopic pits produced, for example, with an electric discharge machining (EDM).

Specifically, in one embodiment, the invention provides an endodontic instrument for use with a powered hand-piece. The instrument includes a shaft extending along an axis and having a first end adapted to engage a receiving chuck of a hand piece. A second end of the shaft tapers inward toward the axis in a direction from the first end to the second end and a portion of the taper near the second end provides a first periphery substantially following a circumference about the axis and presenting an outwardly exposed cutting surface, and a second periphery provides a recessed clearance surface beneath the circumference extending in a line along the axis.

It is thus a feature of at least one embodiment of the invention to provide for a robust endodontic instrument that may replace the helically fluted nickel titanium design which may be prone to breakage.

The tip of the second end may be substantially smooth and, in addition or alternatively, may have a rounded end.

It is thus a feature of at least one embodiment of the invention to reduce the cutting action at the tip of the instrument so as to promote a following of the tool along the existing tooth canal structure.

The cutting surface may be provided by a diamond abrasive coating.

It is thus a feature of at least one embodiment of the invention to providing a cutting surface that does not require the formation of possibly weakening flutes and that may work with a variety of different shaft materials.

Alternatively the cutting surface may be provided by a series of randomly placed microscopic pits.

It is thus a feature of at least one embodiment of the invention to provide an improved cutting surface for endodontic instruments.

The first end of the shaft may be over-molded thermoplastic on a metallic core forming a remainder of the shaft.

It is thus a feature of at least one embodiment of the invention to provide an improved handpiece interface eliminating the need for complex machining operations on small shafts.

The relief surface may be a flat extending along a chord of the circumference.

It is thus a feature of at least one embodiment of the invention to provide a simple relief surface that can be quickly formed by a grinding operation or the like.

The relief surface may be an outwardly concave trough.

It is thus a feature of at least one embodiment of the invention to provide increased passage for fluid and tooth debris.

The shaft may be a stainless steel material.

It is thus a feature of at least one embodiment of the invention to permit the use of a robust shaft material.

These particular features may apply to only some embodiments falling within the claims and thus do not define the scope of the invention.

### BRIEF DESCRIPTION OF THE DRAWINGS

FIG. 1 is a perspective view of the endodontic instrument of the present invention linked to cross-sections at various positions along its length and showing a handpiece, in phantom, to which it may connect;

FIG. 2 is a fragmentary detailed view of the tip of the endodontic instrument of FIG. 1 showing its freedom from cutting surfaces;

FIG. 3 is a cross-sectional view through the shaft of the endodontic instrument of FIG. 1 as may be treated by an electrical discharge machining to create a series of surface pits providing a cutting action;

FIG. 4 is a side elevational view of fixturing for the EDM machine of FIG. 3 showing extension of the tip of the instrument beyond the EDM tool for limiting the formation of cutting surface in the tip area;

FIG. 5 is a cross-sectional view through the shaft of the instrument of FIG. 1 showing alternative relief designs;

FIG. 6 is a side elevational view of an alternative embodiment of the endodontic instrument having a flexible abrasive whip; and

FIG. 7 is a cross-sectional view through a tooth during use of the endodontic instrument of FIG. 6 showing a spiraling action of the whip which provides flutelike ejection of cut material.

### DETAILED DESCRIPTION OF THE PREFERRED EMBODIMENT

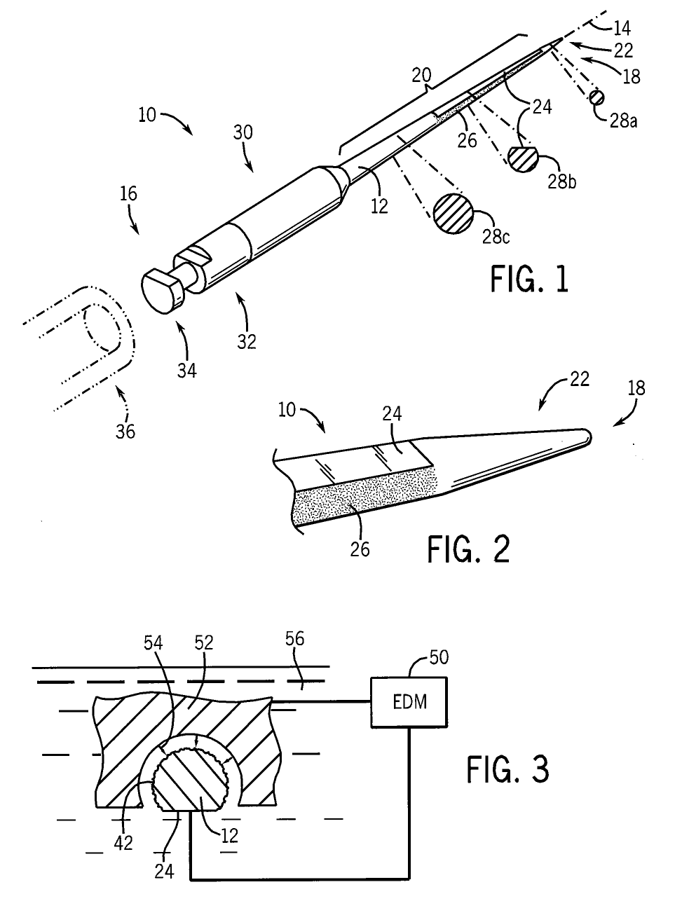

Referring now to FIG. 1, an endodontic instrument 10 of the present invention may provide a shaft 12 extending along an axis 14 between a first end 16 and a second end 18.

A first length 20 of the shaft 12 provides a taper of decreasing diameter as one moves along the shaft 12 toward the second end 18 terminating at a tip 22 having a rounded non-cutting end. The length 20 of the shaft 12 is desirably constructed of a metallic material such as stainless steel, aluminum titanium, or nickel titanium.

A relief channel 24 extends along a portion of the length 20 near the second end 18 stopping before the tip 22. The relief channel 24 provides a relief surface permitting the expulsion of cut tooth material from a channel to be formed in a tooth (not shown) by rotation or reciprocation of the instrument 10 about axis 14. The relief channel 24 may extend generally along but not necessarily parallel to axis 14 and in a preferred embodiment follows the taper of the shaft 12.

A periphery of the shaft 12 adjacent to the length of the relief channel 24 but outside of the relief channel 24 may provide a cutting surface 26, for example, by means of a diamond or other abrasive materials including for example abrasive material coated on that surface or by microscopic pits formed in that surface as will be described.

A cross-section 28a at the tip 22 will generally be circular whereas a cross-section 28b at the portion of the length 20 holding the relief channel 24 will be noncircular as a result of the relief channel 24. A portion of the length 20 beyond the relief channel 24 toward the first end 16 will again have a circular cross-section 28c larger than cross-section 28a as a result of the taper.

As one moves along the shaft 12 from the portion of the length 20 toward the first end 16, the shaft 12 increases in diameter abruptly to provide a handle section 30 that maybe integrally formed with the metal of the shaft 12 at length 20, for example, by machining the appropriate taper in a cylindrical rod on a lathe or the like.

An over-molded plastic portion 32 may be positioned at the first end 16 (over a smaller diameter boss machined extending out of the end of the handle section 30) to provide key surfaces 34 (for example flats and notches) allowing the first end 16 to be received and retained by a handpiece 36 that provides powered reciprocation rotation or the like. The molded plastic portion 32 may be formed of a thermoplastic including glass fibers or the like to provide torsional resilience to this portion.

Referring now generally to FIGS. 2 and 5, the cross-section 28a of the tip 22 may be sized to have a radius curving beneath the relief channel 24 so that it may maintain its circular cross-section and maybe devoid from cutting materials or the effect of a cutting edge of the relief channel 24 so as to help pilot in the instrument 10 along the natural canal of the tooth. The relief channel 24 is preferably along a chord of a circumference 38 taken in cross-section at points along the length 20. Alternatively the relief channel 24 may be slightly outwardly convex (24″) or an outwardly concave trough (24′) in either case to provide a passageway in the generally circular bore that will be formed by the instrument 10 allowing movement of liquid and removed tooth debris during the cutting process.

In one embodiment, the total length of the endodontic instrument 10 may be approximately 1 inch with the length 20 of the shaft being approximately 0.75 inches and of the length of the tip being approximately 0.040 inches. The handle section 30, for example, may have a diameter of 0.09 inches. The rounded end of the tip 22 may be, for example, a 45° chamfer or a series of successive chamfers defining a non cutting tip. It is anticipated that the endodontic instrument 10 will be provided in a variety of sizes meeting the ISO standards of 20-04, 20-06, 30-08, 40-10, 50-12 as well as others.

When the cutting surface is formed by a diamond abrasive 44 or by microscopic pits 42, the cutting surface is preferably but not necessarily applied only to the circumference 28 outside of the relief channel 24. Diamond abrasive may, for example, be attached by a nickel-plating process known in the art. Other abrasive materials may also be used including carbon boron nitride, carbide, zirconium, and various ceramics.

Referring now to FIG. 3, when the cutting surface is formed from microscopic pits 42, these pits may be generated through the use of an electronic discharge machine 50 having one electrode connected to a tool 52 and the other electrode connected to the shaft 12 of the instrument 10. The tool 52 may have a channel 54 cut therein conforming generally to the taper of the shaft 12 in the vicinity of the relief channel 24. The EDM machine 50 may be adjusted for high current flows to produce sparks 54 generating the microscopic pits 42 in the outer surface of the shaft 12. The current may be adjusted to produce pits of the desired size in a particular material, for example stainless steel. As is understood in the art, the tool 52 and shaft 12 may be immersed in a fluid 56. The tool 52 may be constructed, for example, of graphite or copper material or the like.

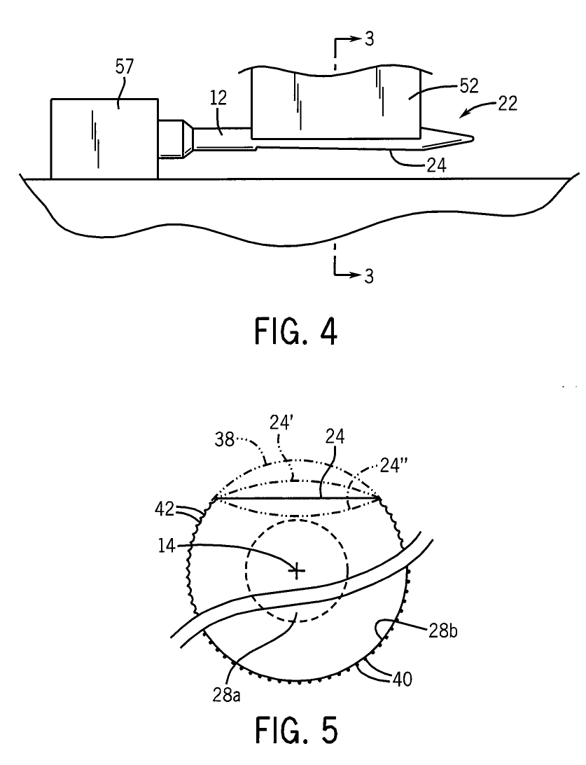

Referring to FIG. 4, in one embodiment, the tool 52 may cover approximately half of the circumference of the shaft 12 and may extend only along the length 20 of the shaft 12 for the extent of the relief channel 24 to stop short of the tip 22 and the shaft 12 above the relief channel 24 thereby limiting the formation of the cutting surface to the area of the relief channel 24 (but not within the relief channel 24). The shaft 12 may be rotated slightly to provide for the necessary coverage of the periphery of the shaft 12 as supported in a retaining chuck 56.

During use, the instrument 10 may be inserted into a tooth for cleaning of the coronal and mid-root portion of the tooth's root. The combination of the taper which provides a generally conical shaft and a straight relief channel 24 provides sufficient debris removal to prevent locking in the tooth canal during rotation.

The microscopic pits produced by the EDM machine 50 are generally too small to be resolved by the naked eye but produce a surface that is generally rough looking. Other possible techniques for producing these pits include photo etching processes in which the length 20 is coated with a photo resist selectively removed after photo exposure of areas in which pits should be formed. Dipping in a mild acid then provides for pit formation. Patterned pits, for example, in herringbone patterns or lines or the like may also be possible with this process. In addition it may be possible that to use a bead blasting or sandblasting or other mechanical process to create the necessary microscopic pits or scores providing a required cutting action.

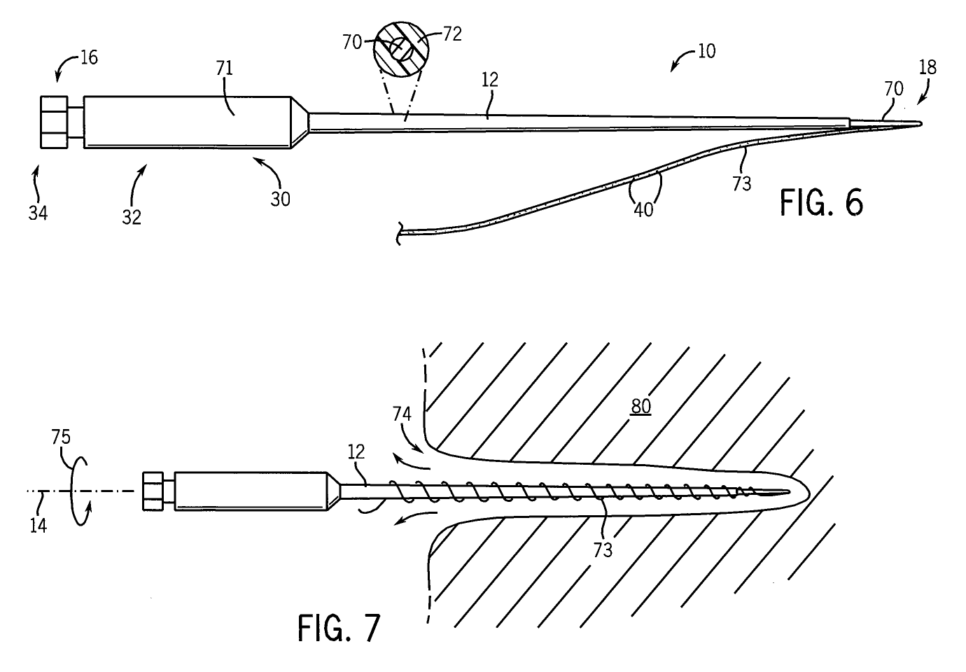

Referring now to FIG. 6, in an alternative embodiment, the instrument 10 may provide a shaft 12 having a metal core 70 over-molded with a polymer 72 to provide similar elements to over-molded plastic portion 32 and key surfaces 34 described above. The polymer 72 may include torsion resistant glass fibers 71 and the metal core 70 may, for example, be stainless steel. The metal core 70 may be exposed at the second end 18 and attached, for example by welding, to an end of a flexible abrasive whip 73. The flexible abrasive whip 73 may be, for example, a metallic wire (such as stainless steel) coated with an abrasive such as diamond 40, and is attached to extend back toward first end 16 so that it may lie generally along the shaft 12.

Referring now to FIG. 7, when this instrument 10 of this embodiment is rotated, for example clockwise, by the handpiece 36 (shown in FIG. 1) in a canal 74 of a tooth 80, rotation of the shaft 12, as indicated by arrow 75, causes the abrasive whip 73 to wrap around the shaft 12 in a helix to create a virtual flute that is able to clean and shape the canal system at the end of a tooth's root (apical portion) removing debris in the manner of an Archimedean screw pump.

These instruments contrast with current endodontic files on the market which have flutes that have been machined into the metal blank create the file cut much the way a wood planer is able to remove slivers of wood. The problem remains that these file flutes engage in the hard and soft tissue in the tooth's root canal and bind, causing file breakage due to torsional stress. The present invention employing a more evenly distributed cutting surface removes tooth material more like using sandpaper to smooth a wood surface. Thus, the instruments do not bind in the soft or hard tissue of the root canal. This lack of binding eliminates breakage from torsional stress.

The present invention may provide for multiple relief channels 24 for example on opposite sides of the shaft 12, if additional relief is desired. In addition, in some applications, the tip 22 may be made cutting (as opposed to non-cutting) by extending the cutting surface to the tip 22 or by providing flutes or axial edges or the like at the tip 22. It will be appreciated that by simple modification of the over-molded plastic portion 32, present invention may be used as a hand tool without the hand piece 36.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What is claimed is:

1. An endodontic instrument for use with a powered hand-piece comprising:
a shaft extending along an axis and having
a first end adapted to engage a receiving chuck of a hand piece and
a second end tapering toward the axis in a direction from the first end to the second end, a portion of the taper near the second end providing a first periphery substantially following a circumference about the axis and presenting an outwardly exposed cutting surface and a second periphery providing a recessed relief surface beneath the circumference extending in a line along the axis.

2. The endodontic instrument of claim 1 wherein a tip of the second end is substantially smooth.

3. The endodontic instrument of claim 2 wherein the tip has a rounded end.

4. The endodontic instrument of claim 1 wherein the cutting surface is provided by a diamond abrasive coating.

5. The endodontic instrument of claim 1 wherein the cutting surface is provided by a random series of microscopic pits.

6. The endodontic instrument of claim 1 wherein the first end of the shaft is over-molded thermoplastic on a metallic core forming a remainder of the shaft.

7. The endodontic instrument of claim 1 wherein the relief surface is flat extending along a chord of the circumference.

8. The endodontic instrument of claim 1 wherein the relief surface is an outwardly concave trough.

9. The endodontic instrument of claim 1 wherein the shaft comprises a stainless steel material.

10. An endodontic instrument for use with a powered hand-piece comprising:
a shaft extending along an axis and having
a first end adapted to engage a receiving chuck of a hand piece and
a second end tapering toward the axis in a direction from the first end to the second end, a portion of the taper near the second end providing an outwardly exposed cutting surface formed of a series of randomly placed microscopic pits.

11. The endodontic instrument of claim 10 wherein a tip of the second end is substantially smooth.

12. The endodontic instrument of claim 11 wherein the tip has a rounded end.

13. The endodontic instrument of claim 10 wherein the taper provides a first periphery substantially following a circumference about the axis and presenting an outwardly exposed cutting surface and a second periphery providing a recessed clearance surface beneath the circumference.

14. The endodontic instrument of claim 10 wherein the shaft comprises a stainless steel material.

15. A method for manufacturing an endodontic instrument comprising:
(a) forming a metallic shaft extending along an axis and having a first and second end, the second end tapering toward the axis in a direction from the first end to the second end; and
(b) placing the shaft proximate to an electrical discharge machining tool and applying a voltage across the tool and shaft to form a set of randomly placed microscopic pits in at least a portion of an outer periphery of the metallic shaft.

16. The method of claim 15 wherein a tip of the second end is protected from electrical discharge to be substantially smooth.

17. The method of claim 15 wherein the taper provides a first periphery substantially following a circumference about the axis and presenting an outwardly exposed cutting surface and a second periphery providing a recessed clearance surface beneath the circumference.

18. The method of claim 15 wherein the shaft comprises a stainless steel material.
